(19) United States
(12) Patent Application Publication
(10) Pub. No.: US 2006/0294104 A1
(43) Pub. Date: Dec. 28, 2006

(54) Database processing and management

(76) Inventors: Robert W. Morrison, Walpole, MA (US); Paul E. D'Eon, Bolton, MA (US)

Correspondence Address: FOLEY HOAG, LLP;PATENT GROUP, WORLD TRADE CENTER WEST, 155 SEAPORT BLVD, BOSTON, MA, 02110, US

(21) Appl. No.: 11/188,143

(22) Filed: Jul. 22, 2005

Related U.S. Application Data
(60) Provisional application No. 60/590,849, filed on Jul. 23, 2004.

(51) Int. Cl. G06F 17/30

(52) U.S. Cl. 707/9

(57) ABSTRACT

A data-retrieval system maintains a database of records with which it associates respective security keys. It uses those security keys as a basis for deciding whether to grant access to the records. It additionally maintains organizational information that lists relationships among positions within an organization. When a requestor requests access to a record in the database, the system associates zero or more positions with the requestor, typically by determining which position or positions within the organization the requestor occupies. It additionally determines which, if any, other positions within the organization bear a predetermined relationship to any such occupied position, and it assembles a key list that includes keys that it has associated with all such positions. The way in which the system determines whether to grant the requestor access to the record is to determine whether the security key associated with that record matches any key in the key list.

### CROSS-REFERENCE TO RELATED APPLICATION

The present application claims the benefit of U.S. Provisional patent application Ser. No. 60/590,849, which was filed on Jul. 23, 2004, by Kucan et al. for Systems and Methods for Database Processing and Management and is hereby incorporated by reference.

### BACKGROUND OF THE INVENTION

1. Field of the Invention

The present invention concerns data security.

2. Background Information

In many organizations, compensation associated with a given period depends quite directly on very quantifiable performance measures. Compensation for a commission-based sales force is a prime example, although there are many different incentive systems for which this is true. In such systems, it is often desirable for the personnel involved to have access to the data on which their compensation is based. Typically, the relevant data are part of a database that includes other data, from which the enterprise desires to restrict various personnel's access. This makes it necessary to assign different personnel respective access rights, i.e., to specify for each person the portions of the database to which he will be accorded access. In large organizations, in which there are thousands of personnel and millions of records, updating the permissions as personnel are added to the organization, leave it, and change their positions can become onerous.

### SUMMARY OF THE INVENTION

We have found a way of greatly expediting security updates. Our approach takes advantage of the fact that in many cases information that represent relevant organizational structures are available or can be provided. Our approach is to generate permissions in an automated manner from such organizational information. That is, rather than explicitly and directly updating permissions for individual records, an administrator can merely change the data that represent the organization's structure, and the automated system then infers the appropriate permissions, without requiring further input from the administrator (although in some embodiments the administrator may have the option of additionally making explicit permission assignments).

Although there are many ways to implement this concept, its implementation will typically take the form of employing keys associated with respective records to which access is to be controlled. Those keys may have been generated specifically for security purposes and associated with respective records, but it will be more typical for the security keys to be values that are associated with those records for other purposes. Indeed, they may be fields in those records. To determine whether an access-requesting entity (e.g., a salesman) is to be granted access, the system consults the organizational information and collects from it keys that are associated with the organizational positions that the organizational information indicates are occupied by the access-requesting entity. The result is a key list.

In least some embodiments will include in the key list not only each key associated with a position occupied by the access-requesting entity but also keys associated with positions that bear some specified relationship to the thus-occupied positions. For example, keys associated with positions that the organizational data indicate report to a position that the access-requesting entity occupies may also be included in the key list. In any event, if a security key associated with the record matches a key in the key list that has been assembled for the access-requesting entity, the system will accord that entity access to the record.

### BRIEF DESCRIPTION OF THE DRAWINGS

The invention description below refers to the accompanying drawings, of which:

FIG. 1 is a block diagram representing communications between a data-retrieval system and a user;

FIG. 2 is a block diagram of a computer system that can be used to implement the data-retrieval system;

FIG. 3 is a format diagram depicting a record in a table to whose data a requestor entity is seeking access;

FIG. 4 is a diagram of an organizational structure of which the illustrated data-retrieval system contains a description;

FIG. 5 is format diagram depicting records in tables used to describe organizational structures such as the one in FIG. 4;

FIG. 6 is a flow chart that depicts in simplified form the routine that a data-retrieval system may use to respond to a requester's inquiry;

FIGS. 7A and 7B together depict an SQL statement for assembling a key list for an access-seeking entity; and

FIG. 8 is a block diagram that depicts in more detail one of the operations in the FIG. 6 flow chart.

### DETAILED DESCRIPTION OF AN ILLUSTRATIVE EMBODIMENT

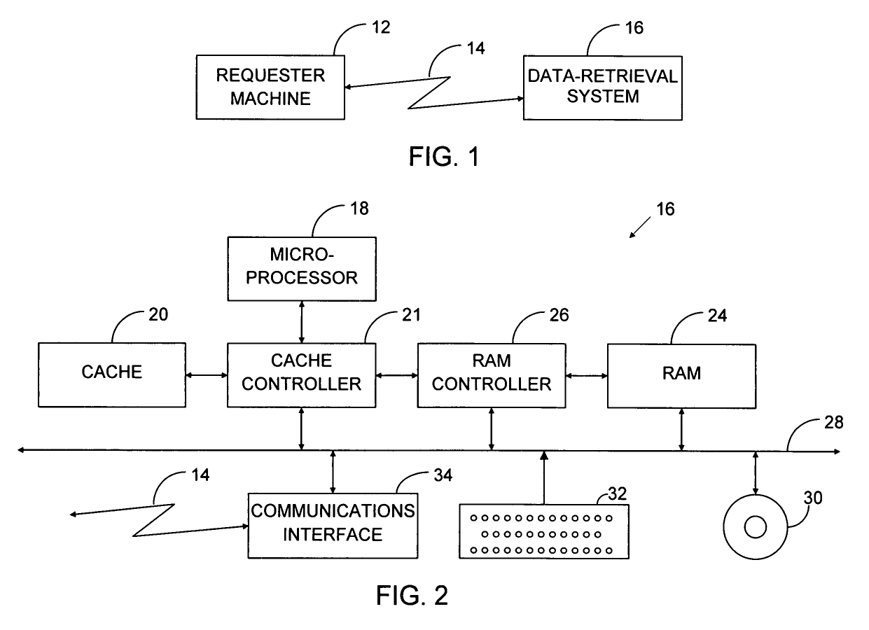

There are myriad situations in which a requesting entity may seek access to records, and the present invention's teachings are applicable to a wide variety of them. For the sake of concreteness, though, we will describe the invention by reference to an example that FIG. 1 depicts in a highly simplified manner. Let us assume that a data requester such as a sales manager seated at a computer or other communications device 12 is seeking access to the data on which his compensation has been or will be based. Through an appropriate communications channel 14, such as the Internet or a virtual private network, he sends a request to a data-retrieval system 16. In installations where the present invention's advantages will be most manifest, the computer system that embodies the data-retrieval system will include multiple machines that are in some fashion in communication with each other and that control access to storage devices in which the requested data reside. For the sake of simplicity, though, we assume here that the illustrated embodiment's data-retrieval system is implemented entirely in a single machine.

The particular type of machine employed for this purpose is not critical, but FIG. 2 depicts one possible architecture. Data that a microprocessor 18 uses and instructions for operating on them may reside in on-board cache memory or be received from further cache memory 20, possibly through the mediation of a cache controller 22. That controller 22 can in turn receive such data from system read/write memory (“RAM”) 24 through a RAM controller 26 or from various peripheral devices through a system bus 18. The memory space made available to an application program may be “virtual” in the sense that it may actually be considerably larger than RAM 14 provides. So the RAM contents will be swapped to and from a system disk 30.

Additionally, the actual physical operations performed to access some of the most-recently visited parts of the process's address space often will actually be performed in the cache 20 or in a cache on board microprocessor 18 rather than in the RAM 24. Those caches would swap data and instructions with the RAM 24 just as RAM 24 and system disk 30 do with each other.

Independently of the particular memory arrangement that a particular workstation employs, it will typically include some type of user-input device such as a keyboard 32 or mouse (not shown) as well as a communications interface 34 for communications with various requesters.

As was stated above, the present invention's teachings do not require the architecture that FIG. 2 depicts. Indeed, most embodiments' architectures will differ from it. But any data-retrieval system that employs the present invention's teachings will afford access to data that reside on one or more storage devices, of which FIG. 2's system disk 30 is a representation. Such persistent storage will also contain the programming that configures the computer to perform the functions described below. The present invention's teachings can be applied to data stored in essentially any format, and the present invention's teachings can also be used to afford access selectively with essentially any granularity. In most embodiments, though, the system will employ a commercial database-management system that implements a relational-database model, which manipulates logical tables of which each comprises some number of records that have a format common to all of that table's records. Although the present invention can and often will be employed in arrangements in which the requesting entity is afforded access to the contents of less than all of a given record's fields, we will assume for the purposes of discussion that the granularity at which access decisions are made is that of a complete record.

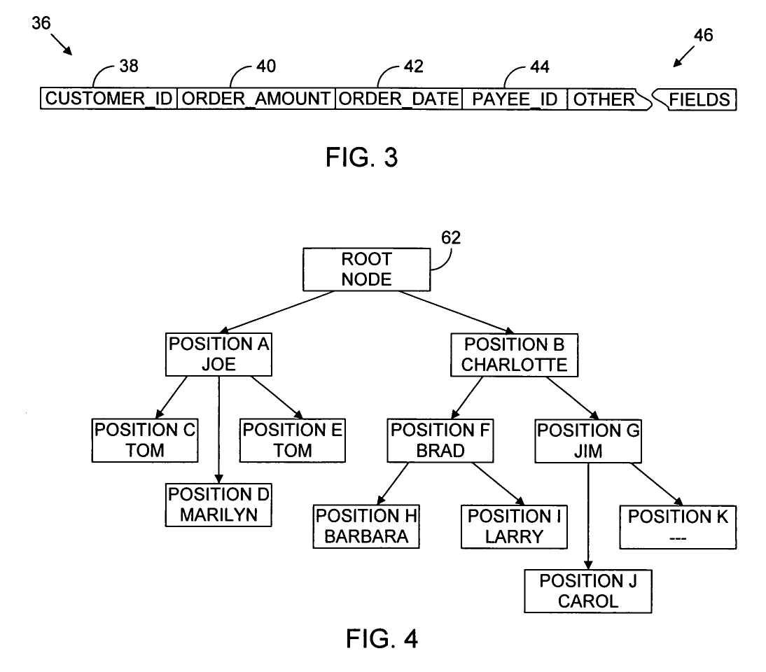

For example, let us assume that the record format for one of the tables is the one that FIG. 3 depicts. In that drawing, a simplified transaction-record format 36 is represented as including a field 38 that identifies the customer that placed the order represented by the record, a field 40 that represents the dollar value of that order, a field 42 that represents the date of the order, a field 44 that represents the salesman or other entity responsible for the order (and referred to as a “payee” because we are here concerned with the incentive compensation that is to result from such orders), and further fields 46, which FIG. 3 does not name explicitly. Although the data to which a user requests access will often reside in more than one table, and although different tables will typically have different record formats, we show only one in FIG. 3.

In addition to such tables, i.e., to the tables that contain the data to which access is to be controlled, systems that employ the present invention's teachings will additionally include organizational data. The organizational data describe positions within the organization and relationships among those positions. In most embodiments it will also list the identities of the entities (typically people) that occupy those positions. The organizational data will often represent data that conceptually are of the type that FIG. 4 depicts. That is, each of one or more portions of the organization can be represented by a tree structure, in which each node represents a position within the organization. Although each position has a unique identity, a given position can belong to more than one such tree. FIG. 4's arrows exemplify one type of relationship that the organizational data may list. Specifically, the arrows are directed from a parent node to a child node, in this case to indicate a reporting relationship: a child node represents an organizational position that reports directly to the organizational position represented by that node's parent, and a descendant node represents an organizational position that reports directly or indirectly to any organizational position represented by an ancestor of that node's parent. (A first node is a descendant of a second node, which is thereby the first node's ancestor, if the first node is (1) a child of the second node or (2) a child of one of the second node's descendants.)

In addition to representing an organizational topology, the organizational data usually will also identify the entities that occupy those positions. In most cases, the entities that occupy the positions will be natural persons, although in some cases they may, for instance, be manufacturers'-representative companies. In any event, the relationship between occupants and positions are not necessarily one-to-one; in FIG. 4, for example, occupant Tom occupies two different positions, and position K is unoccupied.

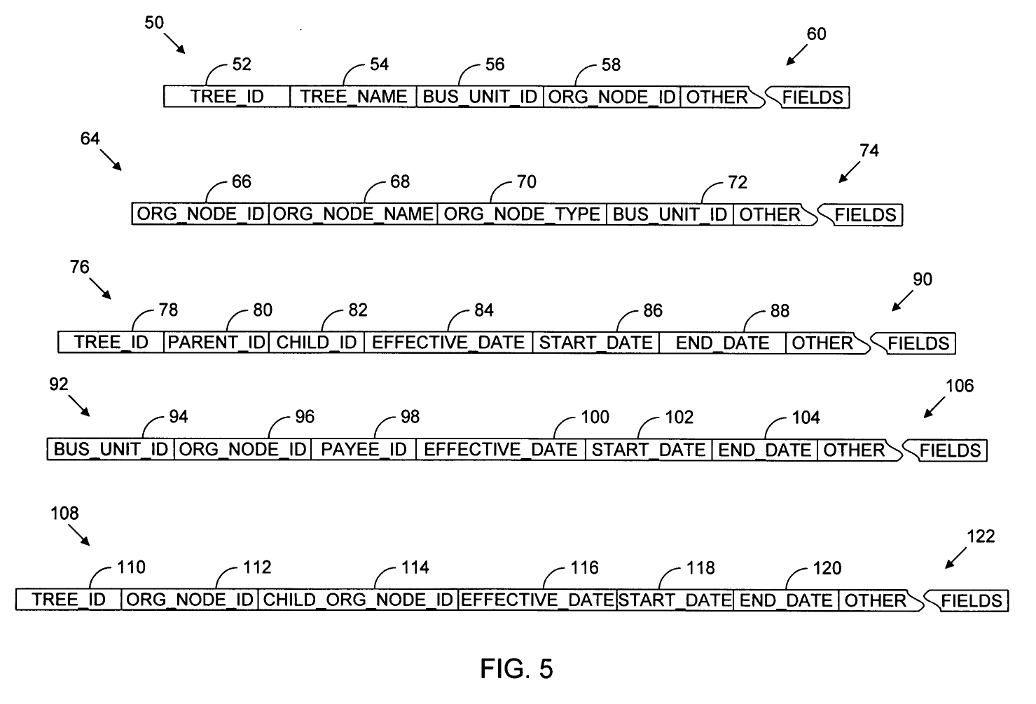

Although those skilled in the art can readily conceive of data structures that are specially designed to represent such relationships, most implementations will probably store them for manipulation by a database-management system that employs the relational, table-based idiom. For example, the illustrated embodiment stores the organizational data in five tables, whose respective record formats FIG. 5 depicts.

In FIG. 5, format 50 is the record format of a tree table, which lists trees that represent relevant portions of the organization. Each record in the tree table represents a different tree and includes fields such as a field 52 that contains a unique tree identifier, a field 54 that contains a descriptive name for the tree, a field 56 that contains an identifier that uniquely identifies the business unit of which the tree describes all or part, a field 58 that uniquely identifies the tree's root node, which may be the highest organizational position that the tree includes, and other fields 60, which may, for instance, be dedicated to maintaining an audit trail of organizational-data modifications.

Of course, organizational data do not need to be represented in the manner that FIG. 5 depicts, and data that do include a tree table do not necessarily require the specific fields shown in record format 50, but that format is convenient. Note that, in order to give a tree-like representation, FIG. 4 includes a root node 62 that does not really represent a position in the organization; Joe and Charlotte may share overall management responsibility. To represent such a situation, FIG. 5's field 58 for the record representing that tree may include a distinguished, null value.

Whereas the tree table lists the trees, a position table whose records conform to format 64 lists individual organizational positions in the trees. For example, a given record in the organizational-position table may include a field 66 containing an identifier that uniquely identifies the node represented by the record, a field 68 that contains a descriptive name for the organizational position, a field 70 that specifies the type of position, a field 72 that specifies the business unit to which the position belongs, and further fields 74, which, as was mentioned above, would typically include audit-type and possibly other information. Note that in the illustrated embodiment such an organizational-position record does not identify the particular tree to which the position belongs. Although some implementations that use organizational-position tables may include tree identifiers in those tables' records, the illustrated embodiment omits such fields. This is because providing the tree-membership information instead in tables other rather than the organizational-position table facilitates describing a position that belongs to more than one tree.

In the illustrated embodiment the tree-membership information is provided in a relationship table, one whose record format is format 76. Each record can be thought of as representing one of the relationships in a given tree; one entry may, for instance, be thought of as corresponding to a respective one of FIG. 4's reporting-relationship-representing arrows. In the illustrated embodiment, in which the relationships represented are tree nodes' parent-child relationships, or, less abstractly, reporting relationships between organizational positions, format 76 includes a field 78 that identifies the tree in which the relationship is found. That format also includes fields 80 and 82, which respectively represent the position to which reports are made and the position that does the reporting. It additionally includes fields 84, 86, and 88, which give the relationship's effective, start, and end dates, and it includes other fields 90, too.

Together, the tree table represented by format 50, the organizational-position table represented by format 64, and the relationship table represented by format 76 specify the various trees' topologies, and an assignment table, represented by format 92, lists the assignments of entities (typically people) to the different positions. In the illustrated embodiment, that format includes fields 94 and 96 to identify a business unit and an organizational position within that unit that the entity is occupying. It also includes a field 98 that identifies the occupying entity, fields 100, 102, and 104 that contain the effective, start, and end dates for that entity's occupation of that occupational position, and other fields 106.

To the extent needed for security purposes, the fields described so far completely specify the organizational structure and the personnel that hold the various organizational positions. But the illustrated embodiment additionally employs a further, extended-relationship table, whose information is redundant in light of the other tables but whose arrangement facilitates the use of the information that they contain. The relationship table's record fields 110, 112, 114, 116, 118, and 120 can be thought of as respectively corresponding to the extended-relationship table's record fields 78, 80, 82, 84, 86, and 88. The difference is that, whereas format 76's fields 80 and 82 represent parent and child nodes, fields 112 and 114 represent ancestor and descendant nodes. So, whereas the relationship table would include only two records that list FIG. 4's position B in their parent-indicating fields 80, the extended-relationship table would have six records whose the ancestor-representing fields 112 list it; those records' respective descendant-indicating fields 114 would contain identifiers of positions F, G, H, I, J, and K. Since the extended-relationship table is redundant in view of—and therefore inferable from—the other tables, it can and typically would be generated automatically; when an administrator revises the relationship table, the system would update the extended-relationship table accordingly.

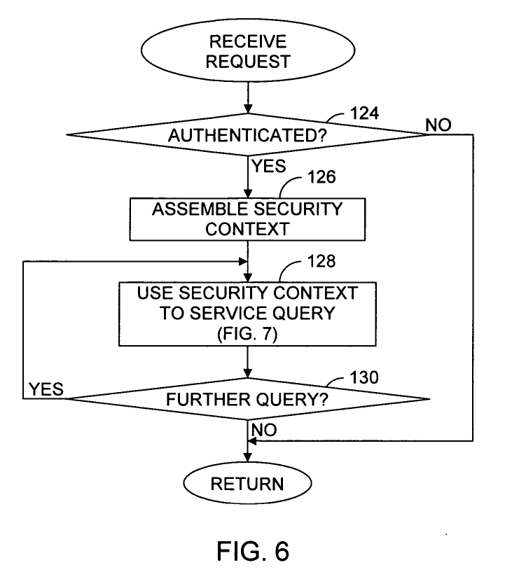

The illustrated embodiment employs this information to decide how to respond to requests for access to information in tables such as the one that FIG. 3's format 36 represents. Suppose that FIG. 1's data-retrieval system 16 receives a request from, say, a manufacturers' representative for information relevant to the compensation the representative is to receive. FIG. 6 is a flow chart that depicts in a simplified manner the approach that the illustrated embodiment employs in responding to the request. As that drawing's block 124 indicates, the requesting entity's credentials are initially tested, and access is denied if the system is unable to authenticate the credentials. As block 126 indicates, the system otherwise assembles a “security context” that it uses, in a manner that will be explained below, to determine which portions of the database it will include in its responses to various queries. As blocks and 128 and 130 indicate, it continues to use the security context to service queries so long as the requesting entity submits them. If the requestor has no further queries (as determined by a log-off message or an absence of activity for a predetermined amount of time), the session ends.

The particular way in which the request is made will vary among embodiments. But it is likely that the requestor machine (represented by FIG. 1's block 12) in most embodiments will be executing a client application that receives requests from a user through a user interface that the client program presents and that sends resultant requests to the data-retrieval system 16 in the form of, say, SQL queries. (Of course, other forms of request can be used instead.) The request would typically target one or more tables (in this SQL example) such as the table that FIG. 3's format 36 represents.

Now, the system may impose many different types of constraints on access to the tables. For example, metadata associated with respective tables may include table-wide is constraints that, say, indicate whether that table's records can be created, read, updated, and/or deleted. Such constraints may differ for different circumstances and include other complexities. Additionally, the security criteria that the system employs may include by-passing in some circumstances the organizational-information-based constraints described below. For the sake of discussion, though, we will ignore those circumstances and any constraints other than those organizational-information-based requirement now to be described.

The system derives that requirement from the security context that, as FIG. 6's block 126 indicates, it has assembled for the session. That requirement can be imposed in many ways. In an arrangement that employs relational-database-model database-management software, though, the retrieval system would typically retrieve data by in essence so modifying the user's request as to add that requirement to other constraints in, say, an SQL query.

Basically, that requirement is that some key associated with the record must match a list of keys that the security context includes. (We use match here broadly. In some embodiments a “match” may not require literal equality between the two values; there may be reasons why some transformation or look-up will be used instead. Still, simple equality is likely to be found preferable in most implementations.) Consider a query that targets the table represented by FIG. 3's format 36. Let us assume that in this implementation the system associates with that table some metadata that, among other things, specify that each record's field 44 contains the security key for that record. What this means is that the system will deliver to the requester no information from a record unless that field in the record matches an entry in a key list that the system has assembled for the requester. (Although the security field will typically reside in a single field, multiple-field keys are, of course, possible.)

In the illustrated embodiment, the system assembles a number of key lists, among which are the position-key and the occupant-key lists. The system assembles the former list as follows. From the authentication operation, the system has associated zero or more organizational positions with the requester. The way in which this happens in the illustrated embodiment is that the authentication operation assigns the requestor a payee-identity value, of the type that the organizational information includes in FIG. 5's field 98. This value uniquely identifies the requester, and, from the table that FIG. 5's format 92 represents, all of the organizational positions that the requestor occupies can be inferred from it.

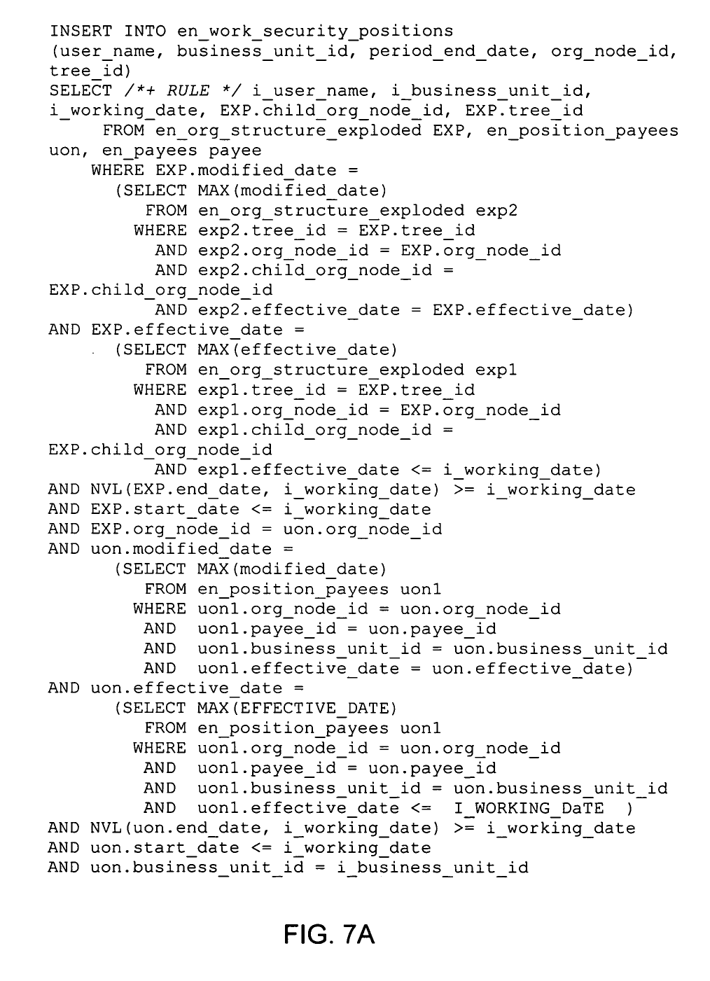

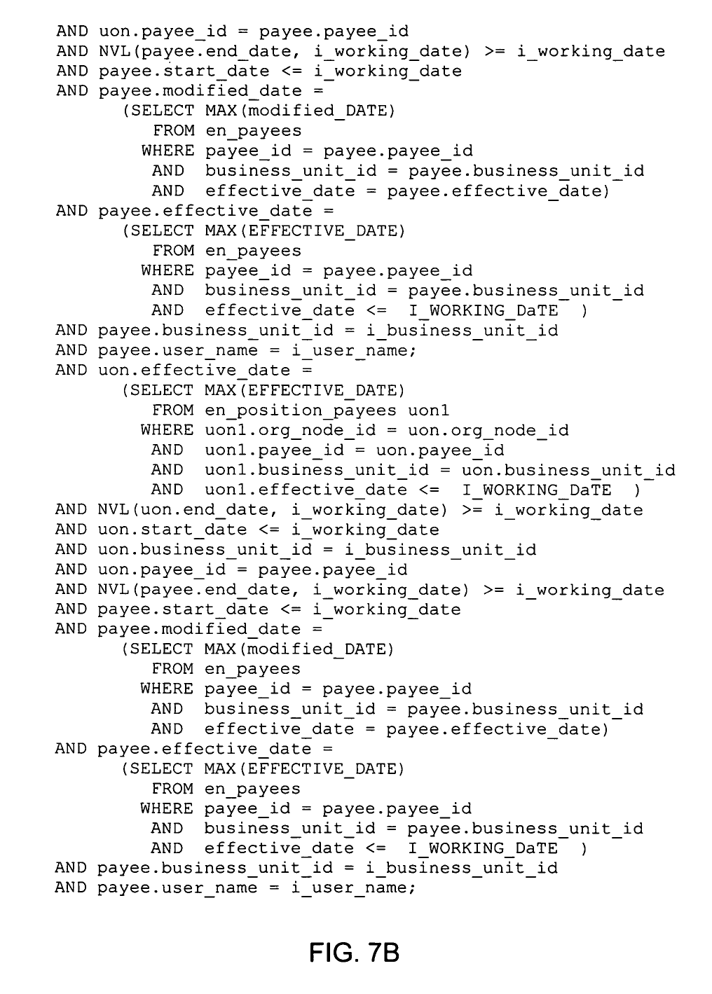

The system copies the unique identity values for all such organizational positions into a position-key list that it is assembling as part of the security context. Additionally, from the table that FIG. 5's format 108 represents, it identifies all descendants of the occupied organizational positions and includes their unique identifiers, too, in the position-key list. In the typical arrangement, the determinations that go into collecting the keys may be somewhat involved as a practical matter, since in most cases the relationships and position assignments vary over time. To illustrate this, FIGS. 7A and 7B depict an SQL statement that uses audit-type information included in FIG. 5's “other fields” to implement such a time-dependent key selection of keys into a table called en_work_security_positions.

The occupant-key list is assembled similarly; the system collects the identifiers of the entities that occupy the requesters' positions and their descendants'. Additional types of key lists may also be collected. For example, some requested data may take the form of predetermined-format reports, to which not all positions are entitled. Report-type keys (not shown) may additionally be associated with the various positions, and those may be collected to assemble a report-key list. Also, different incentive-compensation plans may be associated with different positions, and keys that identify those plans may be collected to afford the requestor access to data about the plans applicable to the positions that the requestor occupies and to descendant positions.

Having assembled the key lists, the system uses them in responding to requests. For example, if the request targets a table of the type represented by FIG. 3's format 36, whose metadata (not shown) indicate that the security field is one that identifies position-occupying entities (as opposed to the positions themselves), the system adds to the query the constraint that the record's payee-identifier field 44 must contain a value that matches one of the values in the payee-identifier security list assembled for the requester. If the request had instead targeted a table whose security field identified a position, report, or is plan, as opposed to an occupying entity, then the illustrated embodiment would instead add the constraint that the security field's contents match one of the keys in the corresponding other security-key list.

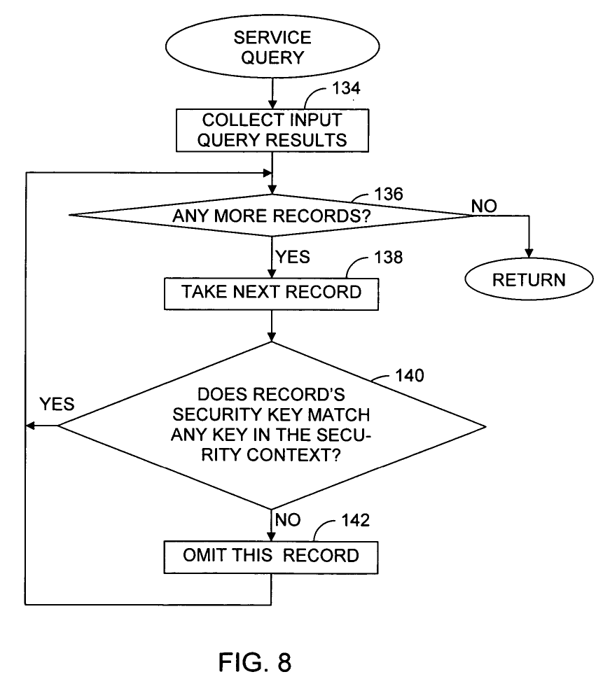

FIG. 8 is a conceptual representation of the query-servicing operation that FIG. 6's block 128 represents. Conceptually, the input submitted by a user can be thought of as a query (which typically could be represented as an SQL statement). As was mentioned above, the input query would in most embodiments be modified in accordance with the security context, and the resultant query would be submitted to database-management routines, which would proceed in whatever manner such routines employ to retrieve the thereby-specified records.

For purposes of exposition, though block 134 instead represents initially executing the input query itself. (Often, the table's metadata will additionally identify certain of its fields that, on a table-wide basis, are not subject to retrieval in certain types of operations, and it is convenient to consider such fields as being withheld as part of FIG. 8's operation 134.) For the resulting set of records, the routine enters a loop that it repeats for each such record, as blocks 136 and 138 indicate. As block 140 indicates, the routine determines for each record whether that record's security key matches any key in one of the security context's key lists. If not, the record is omitted, as block 142 indicates, from the data sent to the requestor.

When all of the records have been thus inspected, the system can make the results available to the requestor.

By automatically inferring permissions from organizational data, the system simplifies the administrator's task of implementing permission changes. Suppose, for instance, that in the FIG. 4 scenario a management change results in position B's reporting to position A, with no change in the personnel who occupy those positions. Under the access rules, Joe should now be accorded access to much more information than previously; whereas before he had access only to the records in which FIG. 3's payee-identifier field 44 contains Tom's or Marilyn's identifier, he now additionally is to be accorded access to those that list Charlotte, Brad, Jim, Barbara, Larry, or Carol. But, rather than laboriously having to change all such records, the administrator needs only to add to the relationship table a single record (in, e.g., FIG. 5's format 76) to specify that position B now reports to position A. So an administrator can be saved a great amount of effort by employing a system that employs the teachings of the present invention, which therefore constitutes a significant advance in the art.

What is claimed is:

1. A computer system configured as a data-retrieval system that:
A) maintains organizational information that lists organizational positions and relationships among the organizational positions;
B) maintains a database of records of which at least some are associated with respective security keys;
C) identifies an access-seeking entity in at least some situations as assigned to at least one of the organizational positions;
D) identifies each organizational position for which the organizational information lists a predetermined relationship to any said organizational position to which the data-retrieval system has identified the access-seeking entity as being assigned;
E) assembles at least one key list comprising keys that the data-retrieval system has associated with the organizational positions thereby identified; and
F) in response to a request from the access-seeking entity for access to a sought record, grants access thereto if and only if that record meets access criteria that in at least some circumstances include the requirement that the database has associated the sought record with a security key that matches a key in at least one said key list.

2. A computer system as defined in claim 1 wherein the predetermined relationship is a descendant relationship.

3. A computer system as defined in claim 1 wherein:
A) the organizational information includes position records, which represent respective said organizational positions; and
B) one said key list is a position-key list in which each key is obtained from the contents of a field in one said position record that represents one of the identified organizational positions.

4. A computer system as defined in claim 3 wherein the predetermined relationship is a descendant relationship.

5. A computer system as defined in claim 3 wherein:
A) the organizational information includes assignment records, which represent assignments of personnel or other entities to the organizational positions that the organizational information lists; and
B) one said key list is an assignment-key list in which each key is obtained from the contents of one or more fields in one said personnel record that represents the assignment to one of the identified organizational positions.

6. A computer system as defined in claim 5 wherein the predetermined relationship is a descendant relationship.

7. A computer system as defined in claim 1 wherein:
A) the organizational information includes assignment records, which represent assignments of personnel or other entities to the organizational positions that the organizational information lists; and
B) one said key list is an assignment-key list in which each key is obtained from the contents of one or more fields in one said personnel record that represents the assignment to one of the identified organizational positions.

8. A computer system as defined in claim 7 wherein the predetermined relationship is a descendant relationship.

9. A computer system as defined in claim 1 wherein the organizational information includes:
A) position records, which represent respective said organizational positions;
B) relationship records, which represent respective said relationships between pairs of said organizational positions; and
C) assignment records, which represent assignments of personnel or other entities to the organizational positions that the organizational information lists.

10. A computer system as defined in claim 1 wherein the organizational information additionally assigns each of the organizational positions to at least one tree.

11. plurality of A computer system as defined in claim 1 wherein the organizational information lists a plurality of trees to which it assigns organizational positions.

12. A computer system configured as a data-retrieval system that:
A) maintains organizational information that lists organizational positions and relationships among the organizational positions;
B) maintains a database of records; and
C) responds to a request from an access-seeking entity for a sought one said record in the database by granting access thereto if and only if that record meets access criteria that in at least some circumstances are based on the organizational information.

13. A storage medium containing instructions readable by a computer system to configure the computer system as a data-retrieval system that:
A) maintains organizational information that lists organizational positions and relationships among the organizational positions;
B) maintains a database of records of which at least some are associated with respective security keys;
C) identifies an access-seeking entity in at least some situations as assigned to at least one of the organizational positions;
D) identifies each organizational position for which the organizational information lists a predetermined relationship to any said organizational position to which the data-retrieval system has identified the access-seeking entity as being assigned;
E) assembles at least one key list comprising keys that the data-retrieval system has associated with the organizational positions thereby identified; and
F) in response to a request from the access-seeking entity for access to a sought record, grants access thereto if and only if that record meets access criteria that in at least some circumstances include the requirement that the database has associated the sought record with a security key that matches a key in at least one said key list.

14. A storage medium as defined in claim 13 wherein the predetermined relationship is a descendant relationship.

15. A storage medium as defined in claim 13 wherein:
A) the organizational information includes position records, which represent respective said organizational positions; and
B) one said key list is a position-key list in which each key is obtained from the contents of a field in one said position record that represents one of the identified organizational positions.

16. A storage medium as defined in claim 15 wherein the predetermined relationship is a descendant relationship.

17. A storage medium as defined in claim 15 wherein:
A) the organizational information includes assignment records, which represent assignments of personnel or other entities to the organizational positions that the organizational information lists; and
B) one said key list is an assignment-key list in which each key is obtained from the contents of one or more fields in one said personnel record that represents the assignment to one of the identified organizational positions.

18. A storage medium as defined in claim 17 wherein the predetermined relationship is a descendant relationship.

19. A storage medium as defined in claim 13 wherein:
A) the organizational information includes assignment records, which represent assignments of personnel or other entities to the organizational positions that the organizational information lists; and
B) one said key list is an assignment-key list in which each key is obtained from the contents of one or more fields in one said personnel record that represents the assignment to one of the identified organizational positions.

20. A storage medium as defined in claim 19 wherein the predetermined relationship is a descendant relationship.

21. A storage medium as defined in claim 13 wherein the organizational information includes:
A) position records, which represent respective said organizational positions;
B) relationship records, which represent respective said relationships between pairs of said organizational positions; and
C) assignment records, which represent assignments of personnel or other entities to the organizational positions that the organizational information lists.

22. A storage medium as defined in claim 13 wherein the organizational information additionally assigns each of the organizational positions to at least one tree.

23. plurality of A storage medium as defined in claim 13 wherein the organizational information lists a plurality of trees to which it assigns organizational positions.

24. A storage medium containing instructions readable by a computer system to configure the computer system as a data-retrieval system that:
A) maintains organizational information that lists organizational positions and relationships among the organizational positions;
B) maintains a database of records; and
C) responds to a request from an access-seeking entity for a sought one said record in the database by granting access thereto if and only if that record meets access criteria that in at least some circumstances are based on the organizational information.
